(19) United States
(12) Patent Application Publication
(10) Pub. No.: US 2013/0214180 A1
(43) Pub. Date: Aug. 22, 2013

(54) SYSTEM AND METHOD FOR PROVIDING LIGHT

(71) Applicant: Samsung Electronics Co., Ltd., (US)

(72) Inventors: Won Don JOO, Incheon (KR); Woo Seok KO, Seoul (KR); Yu Sin YANG, Seoul (KR); Sue Jin CHO, Yongin-si (KR); Sang Don JANG, Suwon-si (KR); Byeong Hwan JEON, Yongin-si (KR)

(73) Assignee: SAMSUNG ELECTRONICS CO., LTD., Suwon-Si (KR)

(21) Appl. No.: 13/768,762

(22) Filed: Feb. 15, 2013

(30) Foreign Application Priority Data
Feb. 20, 2012 (KR) 10-2012-0017092

(51) Int. Cl. F21V 13/04; F21V 7/00

(52) U.S. Cl. CPC F21V 13/04; F21V 7/0025
USPC 250/494.1; 362/247; 362/245

(57) ABSTRACT

An optical system includes a first light source to radiate light in a first wavelength band, a reflector to reflect light from the first light source, a second light source to radiate light in a second wavelength band, and a reflector reflect the second light source. The fourth reflector is set at a first position to allow light from the first light source to each the condenser lens and set to a second position to allow light from the second light source to reach the condenser lens.

### CROSS-REFERENCE TO RELATED APPLICATION

This application claims the benefit of Korean Patent Application No. 10-2012-0017092, filed on Feb. 20, 2012 in the Korean Intellectual Property Office, the disclosure of which is incorporated herein by reference.

### BACKGROUND

1. Field

The present disclosure relates to an illumination optical system.

2. Description of the Related Art

Various optical systems have been developed to inspect the status of a test subject such as a semiconductor wafer or display panel. One system directs light onto the surface of a test subject for purposes of generating an image for inspection.

More specifically, a surface inspection apparatus may radiate uniform and parallel light at a test subject by using an illumination optical system that includes a light source, a reflection mirror configured to reflect the light that is radiated from the light source, and various lenses configured to condense the light reflected from the reflection mirror.

Recently, by using a light source configured to radiate a broadband wavelength of light, a particular band of wavelength is grouped for use of inspection, depending on the type of the defect to be inspected.

However, in a case when the optical power of a particular band is enhanced, the optical power of a different band is decreased. In addition, by decreasing optical power, the amount of the light radiated at the surface of the test subject is not sufficiently obtained, thereby lowering the test efficiency.

### SUMMARY

In accordance with example embodiments, an illumination optical system is provided which is capable of enhancing the illumination efficiency by using a broadband wavelength.

In accordance with an example embodiment, an illumination optical system includes a first light source, a first oval reflection mirror, a first mirror, a second light source, a second oval reflection mirror, and a second mirror. The first light source may be configured to radiate light of a first wavelength band. The first oval reflection mirror may be configured to reflect the light radiated from the first light source. The first mirror may be configured to reflect the light reflected by the first oval reflection mirror toward a condenser lens. The second light source may be configured to radiate light of a second wavelength band. The second oval reflection mirror may be configured to reflect the light radiated from the second light source. The second mirror may be positioned in between the first mirror and the condenser lens, and configured to reflect the light reflected by the second oval reflection mirror toward the condenser lens.

The second mirror may be configured to allow the light reflected by the first mirror to pass therethrough and allow the light reflected by the second oval reflection mirror to be reflected therefrom.

In a case when the first light source is selected as a light source of the illumination optical system, a position of the second mirror may be moved in a way to be diverted away from an optical path that light reaches the condenser lens after being radiated from the first light source.

The illumination optical system may further include a first rod lens and a second rod lens. The first rod lens may be configured to turn light being reflected and incident by the first mirror into uniform light. The second rod lens may be configured to turn light being reflected and incident by the second mirror into uniform light. In a case when the first light source is selected as a light source of the illumination optical system, the first rod lens may be moved to be positioned in between the first mirror and the condenser lens. In a case when the second light source is selected as a light source of the illumination optical system, the second rod lens may be moved to be positioned in between the second mirror and the condenser lens.

A first reflector may be installed around an incidence surface of the first rod lens so as to reflect light, which is not incident onto the incidence surface of the first rod lens among the light reflected by the first mirror, toward the first mirror. A second reflector may be installed around an incidence surface of the second rod lens so as to reflect light, which is not incident onto the incidence surface of the second rod lens among the light reflected by the second mirror, toward the second mirror.

In accordance with another example embodiment, an illumination optical system includes a first oval reflection mirror, a second oval reflection mirror, a mirror, and a condenser lens. The first oval reflection mirror may be configured to reflect light of a first wavelength band that is radiated from a first light source. The second oval reflection mirror may be configured to reflect light of a second wavelength band that is radiated from a second light source, the second oval reflection mirror installed to face the first oval reflection mirror while being spaced apart from the first oval reflection mirror. The mirror may be rotatably installed in between the first oval reflection mirror and the second oval reflection mirror, and configured to reflect the light reflected by the first oval reflection mirror or the light reflected by the second oval reflection mirror. The condenser lens may be configured to condense the light that is reflected by the mirror.

A coating layer may be formed at one surface of the mirror to reflect the light that is reflected by the first oval reflection mirror. A coating layer may be formed at another surface of the mirror to reflect the light that is reflected by the second oval reflection mirror.

The mirror, in a case when the first light source is selected as a light source of the illumination optical system, may be rotated so that the light, which is radiated from the first lamp and is reflected by the first oval reflection mirror, is reflected by the one surface of the mirror toward the condenser lens. The mirror, in a case when the second light source is selected as a light source of the illumination optical system, may be rotated so that the light, which is radiated from the second lamp and is reflected by the second oval reflection mirror, is reflected by the other surface of the mirror toward the condenser lens.

The illumination optical system may further include a first rod lens, and a second rod lens. The first rod lens may be configured to turn light reflected and incident by the one surface of the mirror into uniform light. The second rod lens may be configured to turn light reflected and incident by the other surface of the mirror to uniform light. In a case when the first light source is selected as a light source of the illumination optical system, the first rod lens may be moved to be positioned in between the mirror and the light condenser lens. In a case when the second light source is selected as a light source of the illumination optical system, the second rod lens may be moved to be positioned in between the mirror and the condenser lens.

A first reflector may be installed around an incidence surface of the first rod lens to reflect light, which is not incident onto the incidence surface of the first rod lens among the light reflected by the mirror, toward the mirror. A second reflector may be installed around an incidence surface of the second rod lens to reflect light, which is not incident onto the incidence surface of the second rod lens among the light reflected by the mirror, toward the mirror.

As described above, by having a plurality of lamps each configured to radiate a different wavelength of light and by composing an illumination optical system to be suitable for the reflection of the light radiated from each lamp, the illumination efficiency may be enhanced while using a broadband wavelength.

In accordance with another example embodiment, an illumination optical system comprises a first light source configured to radiate light in a first wavelength band, a first reflector configured to reflect the light from the first light source, a second reflector configured to reflect light from the first reflector toward a condenser lens, a second light source configured to radiate light in a second wavelength band, a third reflector configured to reflect the light from the second light source, and a fourth reflector between the second reflector and condenser lens and configured to reflect the light from the third reflector toward the condenser lens. The fourth reflector is set at a first position to allow light from the first light source to each the condenser lens and set to a second position to allow light from the second light source to reach the condenser lens.

The system further includes a first lens configured to convert light from the second reflector into uniform light and a second lens configured to convert light from the fourth reflector into uniform light. The first lens is set to a position to receive light from the second reflector when the fourth reflector is set to the first position, and the second lens is set to a position to receive light from the fourth reflector when the fourth reflector is set to the second position.

The system further includes a first reflecting surface, coupled to an incident surface of the first lens, to reflect light toward the second reflector and the first reflector, and a second reflecting surface, coupled to an incident surface of the second lens, to reflect light toward the fourth reflector and the third reflector. The first wavelength band may be a ultraviolet wavelength band and the second wavelength band may be a deep ultraviolet wavelength band.

A first optical coating on the second reflector and made of a material to reflect light in the first wavelength band by a greater amount than light in other wavelength bands, and a second optical coating on the fourth reflector and made of a material to reflect light in the second wavelength band by a greater amount than light in other wavelength bands.

The first reflector has two focal positions. The first light source is located at a first focal position and the second reflector is located at a second focal position. The third reflector has two focal positions. The second light source is located at a first focal position of the third reflector and the fourth reflector is located at a second focal position of the third reflector.

In accordance with another example embodiment, an illumination optical system comprises a first light source configured to radiate light in a first wavelength band, first reflector configured to reflect the light from the first light source, a second reflector configured to reflect light from the first reflector toward a condenser lens, a second light source configured to radiate light in a second wavelength band, a third reflector configured to reflect the light from the second light source, and a fourth reflector between the second reflector and condenser lens and configured to reflect the light from the third reflector toward the condenser lens. The fourth reflector may be configured to pass light from the second reflector when light from the first light source is to reach the condenser lens.

The first wavelength band may be a ultraviolet wavelength band and the second wavelength band may be a deep ultraviolet wavelength band.

Also, the system may include a first optical coating on the second reflector and made of a material to reflect light in the first wavelength band by a greater amount than light in other wavelength bands, and a second optical coating on the fourth reflector and made of a material to reflect light in the second wavelength band by a greater amount than light in other wavelength bands.

The system may include the first reflector has two focal positions, the first light source located at a first focal position and the second reflector located at a second focal position, and the third reflector has two focal positions, the second light source located at a first focal position of the third reflector and the fourth reflector is located at a second focal position of the third reflector.

In accordance with another example embodiment, an illumination optical system comprises a first reflector configured to reflect light of a first wavelength band from a first light source, a second reflector configured to reflect light of a second wavelength band from a second light source, and a moveable third reflector between the first and second reflectors, wherein the third reflector moves to a first position to reflect light from the first reflector and wherein the third reflector moves to a second position to reflect light from the second reflector.

The first reflector may be disposed in opposing relation to the second reflector, and the third reflector may rotate between the first and second positions.

Also, the first reflector may have a first focal position corresponding to a location of the first light source and a second focal position corresponding to a location of the third reflector, and the second reflector may have a third focal position corresponding to a location of the second light source and a fourth focal position corresponding to a location of the third reflector.

The system may further include a first optical coating on the first reflector and made of a material to reflect light in the first wavelength band by a greater amount than light in other wavelength bands, and a second optical coating on the second reflector and made of a material to reflect light in the second wavelength band by a greater amount than light in other wavelength bands.

The system may further include a first lens set to a position to receive light from the first reflector when the third reflector is set to the first position, and the second lens is set to a position to receive light from the second reflector when the third reflector is set to the second position.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows an example embodiment of an optical system.

FIG. 2 shows another example embodiment of an optical system with two light sources and reflectors in a first arrangement.

FIG. 3 shows another example embodiment of an optical system with two light sources and reflectors in a second arrangement.

FIG. 4 shows another example embodiment of an optical system in which a reflector is rotated to a first position to receive light from a first light source.

FIG. 5 shows the embodiment of FIG. 4 in which the reflector is rotated to a second position to receive light from a second light source.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments are shown by way of example in the drawings and will be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

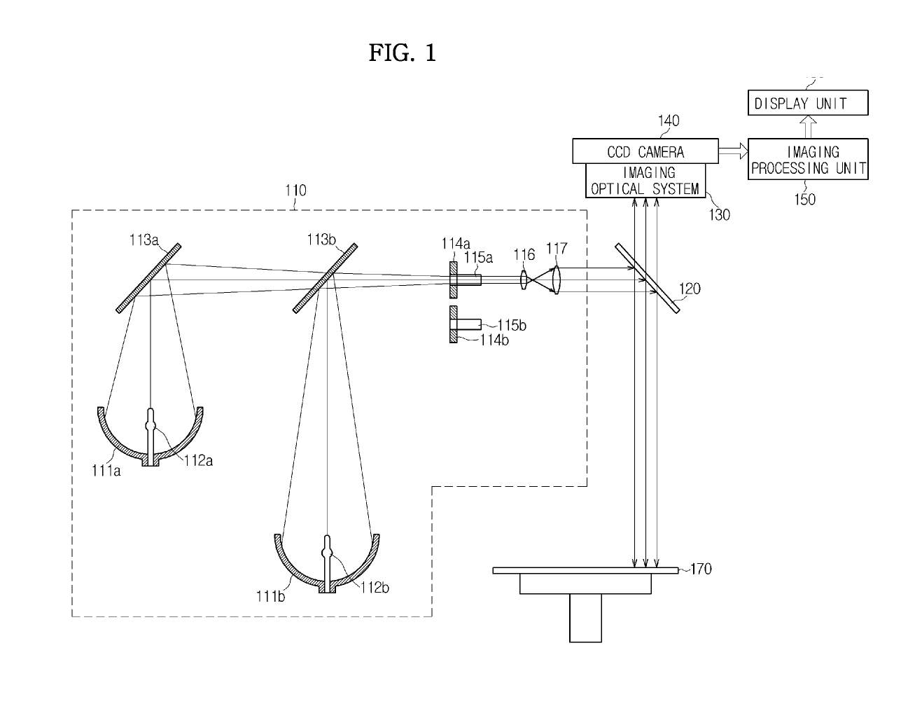

FIG. 1 shows one embodiment of an optical system including an illumination optical system 110 which directs substantially parallel light onto a half mirror 120. The half mirror reflects a particular wavelength of light incident from the illumination optical system and illuminates the surface of a wafer 170.

Light reflected from the surface of the wafer 170 passes through the half mirror 120 and falls incident on an imaging optical system 130. The imaging optical system 130 forms an enlarged image of the light reflecting from wafer 170 and passing through the half mirror 120.

A charge coupled device (CCD) camera 140 converts the enlarged image into an image signal.

An image processing unit 150 processes the image signal generated by the CCD camera 140 to generate image data.

A display unit 160 displays image data generated by the image processing unit 150. An inspector, through the image displayed at the display unit 160, may visually inspect the status of the surface of the wafer 170. In order to precisely inspect the status of the surface of the wafer 170, a sufficient amount of the parallel light is needed to be illuminated on the surface of the wafer 170. This parallel light is generated by the illumination optical system 110.

In accordance with one embodiment, the illumination optical system 110 includes a first lamp 112a, a first oval reflection mirror 111a, a first mirror 113a, a first reflector 114a, a first rod lens 115a, a second lamp 112b, a second oval reflection mirror 111b, a second mirror 113b, a second reflector 114b, a second rod lend 115b, a condenser lens 116, and a collimating lens 117.

The first lamp 112a is a light source which radiates light in a certain wavelength band. In accordance with one embodiment, the first lamp 112a radiates deep ultraviolet (DUV) light at a wavelength, for example, in the range of 200 nm and 300 nm. The first lamp may be installed at a first focus position of the first oval reflection mirror 111a.

The first oval reflection mirror 111a reflects the light radiated from the first lamp 112a to condense light beams on the reflected path. The first oval reflection mirror 111a has a first focus position corresponding to the first lamp 112a and a second focus position where the reflected light is condensed. One or more coating layers may be formed at an interior surface of the first oval reflection mirror 111a, and the number of coating layers and/or the material used to form the coating layer(s) may be determined to maximize the reflection rate of DUV light radiated from the first lamp 112a.

The first mirror 113a, second mirror 113b, first rod lens 115a, condenser lens 116, and collimation lens 117 are positioned along an optical path between half mirror 120 and the first oval reflection mirror 111a.

The first mirror 113a reflects the light that is reflected by the first oval reflection mirror 111a. The first mirror 113a may be located at the position corresponding to the second focus of the first oval reflection mirror 111a, but the position of the first mirror 113a is not limited hereto.

A coating layer may be formed on one surface of the first mirror 113a, that is, the surface onto which the light is incident. As indicated, the number of the coating layers and/or the material(s) used for the coating layers may be determined to maximize the reflection rate of DUV. In another embodiment, the number and/or materials forming the coating layer(s) may be selected to maximize or otherwise enhance the reflection rate of light in a different wavelength band, including various visible bands as well as invisible bands including other UV bands or an infrared band.

The light reflected by the first mirror 113a passes through the second mirror 113b and reaches half mirror 120 by sequentially passing through the first rod lens 115a, the condenser lens 116, and the collimation lens 117.

The first rod lens 115a is configured to perform a role in converting incident light into uniform light. For such, the first rod lens 115a may be provided, for example, in the shape of a prism having a light incident surface and a light emitting surface that are perpendicular to a light axis. The incident and light emitting surfaces may have the same shape or a different shape. In one embodiment, the incident surface and the light emitting surface have a shape in the form of a regular polygon. Examples of a regular polygon include an equilateral triangle, a square, a regular pentagon, and a regular hexagon. The prisms may be formed of glass or another transparent or semi-transparent material. In one embodiment, a fly-eye lens may be used instead of first rod lens 115a.

The first reflector 114a is installed around the incident surface of the first rod lens 115a. The first reflector 114a reflects light which is not incident on the incident surface of the first rod lens 115a, among the light radiated from the first lamp 112a and reflected by the first mirror 113a. The light reflected from first reflector 114a is directed towards the first mirror 113a after passing through second mirror 113b. The light passing through second mirror 113b and onto first mirror 113a is reflected by first mirror 113a onto first oval reflection mirror 111a.

In accordance with one embodiment, light reflected from first mirror 113a may be allowed to pass through second mirror 113b by including a phase change material in mirror 113b. When an electrical signal is applied to the phase change material, mirror 113b may become transparent. Conversely, when another signal is applied, the phase change material may cause one or both surfaces of the mirror to become opaque. In this latter case, a side of mirror 113b facing mirror 113a may become opaque to block light from lamp 112a from reaching mirror 120. In this case only light from mirror 112b may reach mirror 120.

The light incident on the first oval reflection mirror 111a is reflected again by the first oval reflection mirror 111a, and the light that is reflected again is reflected by the first mirror 113a and then passes through second mirror 113b and falls on the incident surface of first rod lens 115a. As such, by installing the first reflector 114a around the incidence surface of the first rod lens 115a, the amount of light lost on the light path can be reduced. The first reflector 114a may be formed in a way to increase or maximize the reflection rate of DUV light.

The second rod lens 115b may be similar to the first rod lens 115a with respect to the role thereof. However, while the first rod lens 115a performs a role in making the light radiated from the first lamp 112a into uniform light, the second rod lens 115b performs a role in making the light radiated from the second lamp 112b into uniform light.

The positions of the first rod lens 115a and second rod lens 115b may be moved according to the type of the light source that is being used at the illumination optical system 110. In particular, in a case when the first lamp 112a is used as a light source at the illumination optical system 110 as illustrated on FIG. 1, the first rod lens 115a may be positioned on the path that the light reaches the half mirror 120 after being reflected at the first oval reflection mirror 111a.

If the second lamp 112b is used as a light source at the illumination optical system 110, the second rod lens 115b may be positioned on the path that the light reaches the half mirror 120 after being reflected at the second oval reflection mirror 111b. The position of the first rod lens 115 may be moved such that the first rod lens 115a is diverted away from the corresponding path of light.

The second lamp 112b is a light source which radiates light in a certain wavelength band. The second lamp 112b, for example, may radiate UV having the wavelength in the range of 300 nm and 450 nm. The second lamp 112b is located at a first focus position of the second oval reflection mirror 111b.

The second oval reflection mirror 111b reflects the light radiated from the second lamp 112b to condense the path of the reflected light. The second oval reflection mirror 111b is located at the first focus position of the second lamp 112b and a second focus position of lamp 112b may correspond to a position where the reflected light is condensed. One or more coating layers may be formed at an interior surface of the second oval reflection mirror 111b, and the number of the coating layers and/or the material used for the coating layer(s) may be determined to maximize the reflection rate of the UV light, or light in another wavelength band, that is radiated from the second lamp 112b.

The second mirror 113b reflects the light reflected by the second oval reflection mirror 111b to introduce the light onto the second rod lens 115b. For such, the second mirror 113b may be installed at the second focus position of the second oval reflection mirror 111b, but the position of the second mirror 113b is not limited hereto.

One or more coating layers may be formed on the incident surface of second mirror 113b. At this time, the number of the coating layers and/or the material used for the coating layer(s) may be determined to maximize the reflection factor of the UV light or light in another wavelength band. In addition, the second mirror 113b may be composed in a way to reflect the light radiated from the second lamp 112b and reflected by the second oval reflection mirror 111b, while allowing the light radiated from the first lamp 112a and reflected by the first oval reflection mirror 111a to pass.

The light reflected by the second mirror 113b reaches the half mirror 120 by sequentially passing through the second rod lens 115b, the condenser lens 116, and the collimation lens 117.

The second rod lens 115b may be configured to convert incident light into uniform light. For example, the second rod lens 115b may be provided in a shape of a prism having an incident surface and a light emitting surface that are perpendicular to a light axis. The incident and light emitting surfaces may have the same or different shapes, and the same is true of the first rod lens 115. For example, the shape of the incident and light emitting surfaces may be a regular polygon. Examples of the regular polygon include an equilateral triangle, a square, a regular pentagon, and a regular hexagon. The prisms may be formed of glass or another transparent or semi-transparent material. The second rod lens 115b may be replaced by a fly-eye lens in an alternative embodiment.

The second reflector 114b is installed around the incident surface of the second rod lens 115b. The second reflector 114b reflects the light which is not incident on the incident surface of the second rod lens 115b among the light radiated from the second lamp 112b. The reflected light is then reflected by the second mirror 113b onto the second oval reflection mirror 111b.

The light incident on second oval reflection mirror 111b is reflected again by the second oval reflection mirror 111b, and the light that is reflected again is reflected by the second mirror 113b and then is incident onto the incident surface of the second rod lens 115b. By installing the second reflector 114b around the incident surface of second rod lens 115b, the amount of light lost on the path may be reduced. The second reflector 114b may be formed in a way to increase or maximize the reflection rate of UV light.

Additionally, in accordance with one embodiment, light in a first wavelength band (e.g., DUV) radiated from the first lamp 112a may be passed and light in a second wavelength band (e.g., UV band) radiated from the second lamp 112b may be reflected, when the position of the second mirror 113b is fixed.

In FIG. 1, light from both light sources is shown to pass through mirror 113b. However, this may not be the case in at least one embodiment. For example, power may be alternatively applied to the light sources. When light is output from source 112a, light source 112b may be turned off. In this case, the light from source 112a passes through mirror 113b. Conversely, when light is output from source 112b, light source 112a may be turned off. In this case, light from source 112b may be reflected by mirror 113b. A control circuit may be included for controlling power to the light sources and/or for controlling positions of the mirrors in accordance with the embodiments described herein.

In other embodiments, both light sources may be activated and mirror 113b may simultaneously pass light from source 112a and reflect light from 112b. An intervening filter may then be added to selectively pass light from either source for passing through a respective one of lenses 115a and 115b.

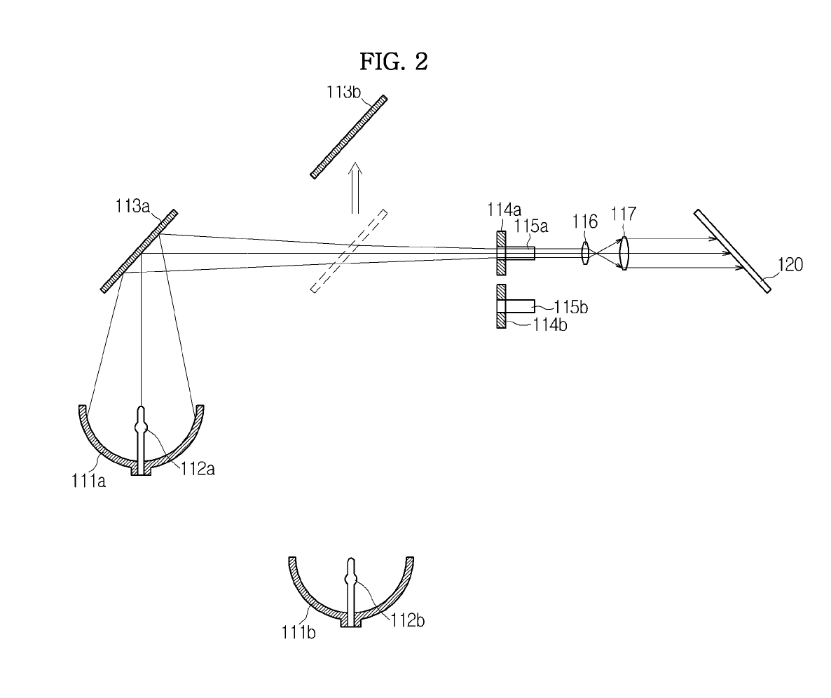

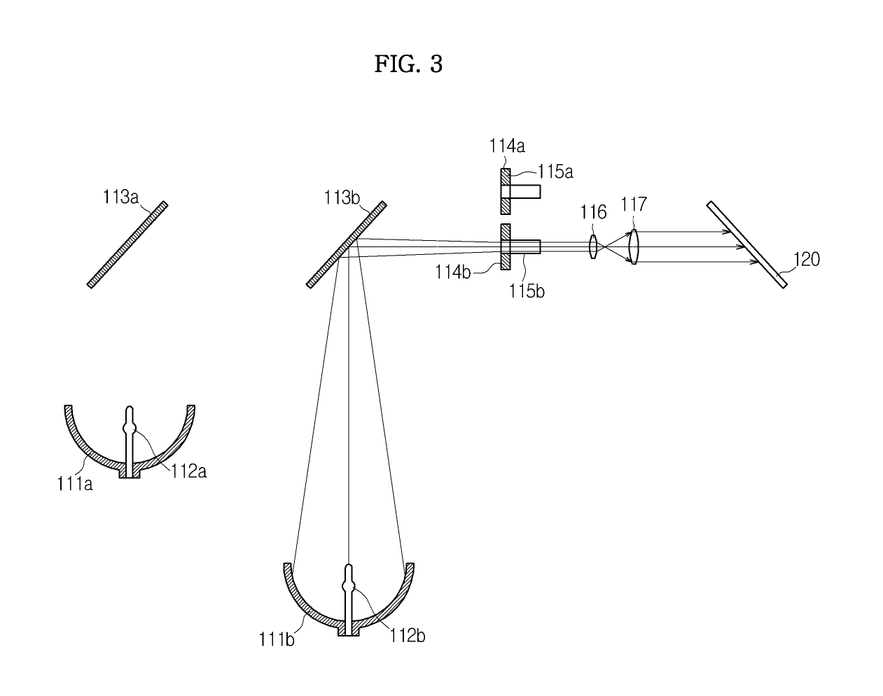

In another embodiment, the position of the second mirror 113b may be moved. These embodiments are described in greater detail below, where FIG. 2 shows an embodiment in which the first lamp is used as a light source and FIG. 3 shows an embodiment in which a second lamp is used as a light source.

In the embodiment of FIG. 2, where the first lamp 112a is used as a light source, the position of the second mirror 113b is moved such that the second mirror 113b is diverted away from the path that light reaches to the half mirror 120 from first lamp 112a. When the position of second mirror 113b is moved and when power is supplied to the first lamp 112a, light in the DUV range is radiated from the first lamp 112a. The radiated DUV light from the first lamp 112a is reflected by first oval reflection mirror 111a and falls incident on the first mirror 113a. The incident surface of first mirror 113a may be coated to maximize the reflection rate of the DUV light.

The light incident on the first mirror 113a is reflected by the first mirror 113a and falls incident on the incident surface of the first rod lens 115a. At this time, the distribution of light is not uniform on the incident surface of the first rod lens 115a. But, on the light emitting surface of the first rod lens 115a, the distribution of the light is uniform. The light that passes through the light emitting surface of the first rod lens 115a sequentially passes through the condenser lens 116 and the collimation lens 117 and reaches half mirror 120.

In FIG. 3 when second lamp 112b is used as a light source, the positions of second mirror 113b and second rod lens 115b are moved such that second mirror 113b and second rod lends 115b are positioned on the light path that reaches half mirror 120 after being radiated from the second lamp 112b.

When the position of the second mirror 113b is moved and when power is supplied to second lamp 112b, UV light is radiated from the second lamp 112b. The radiated light from the second lamp 112b is reflected by the second oval reflection mirror 111b and falls incident on the second mirror 113b. The incident surface of the second mirror 113b may be coated to maximize the reflection rate of the UV light.

The light incident on the second mirror 113b is reflected by the second mirror 113b and falls incident on the incident surface of the second rod lens 115b. At this time, on the incident surface of the second rod lens 115b, the distribution of the light is not uniform. But, the light output from the light emitting surface of the second rod lens 115b has a uniform distribution. The light that passes through the light emitting surface of the second rod lens 115b sequentially passes through the condenser lens 116 and the collimation lens 117 and reaches the half mirror 120.

In accordance with another embodiment, the position of the second mirror 113b is moved according to the type of the light source that is to be used. In this embodiment, a single mirror may be used in place of the first mirror 113a and second mirror 113b and the single mirror may be made to be rotatable. These embodiments are described below

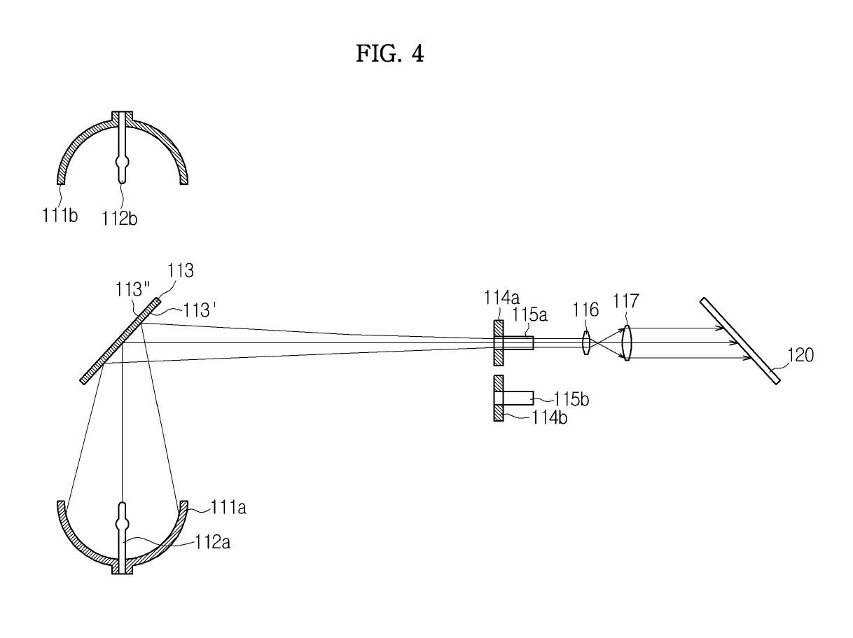

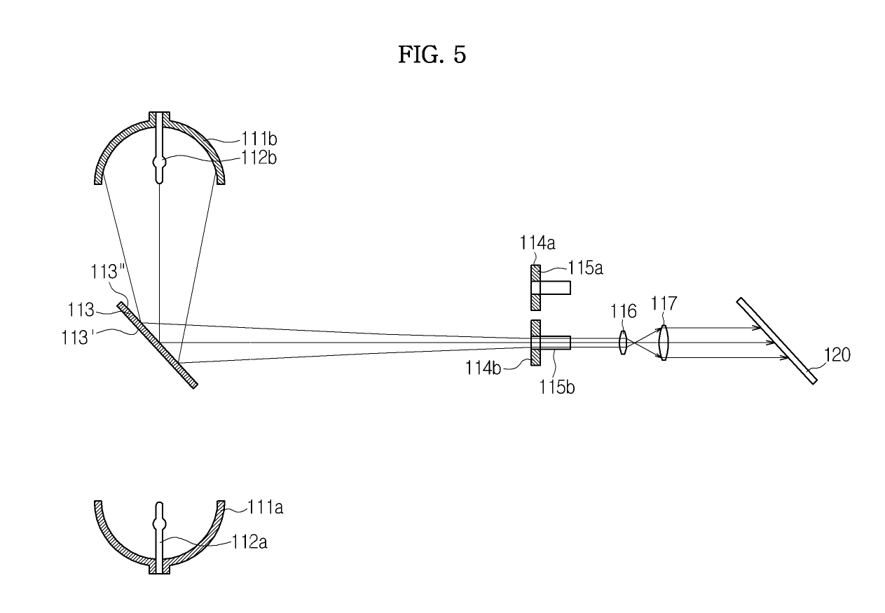

FIG. 4 shows an embodiment where a first lamp is used as a light source in an optical system, and FIG. 5 shown the case where a second lamp is used as a light source with an intervening rotatable mirror.

As shown in FIG. 4, the first oval reflection mirror 111a and the second oval reflection mirror 111b are configured to face each other while being spaced apart in a certain distance. A mirror 113 is rotatably installed between the first oval reflection mirror 111a and the second oval reflection mirror 111b. A coating layer may be formed on one surface 113′ of the mirror 113 to maximize the reflection rate of light in the DUV band, and a coating layer may be formed on the other surface 113″ of mirror 113 to increase or maximize the reflection rate of light the UV band.

In a case when the first lamp 112a is to be used as a light source as shown in FIG. 4, the position of the first rod lens 115a is moved such that the first rod lens 115a is positioned in between the mirror 113 and the condenser lens 116. The mirror 113 is rotated so that the light radiated from the first lamp 112a may be reflected toward the first rod lens 115a.

When power is supplied to the first lamp 112a, DUV light is radiated from the first lamp 112a. The light radiated from the first lamp 112a is reflected by the first oval reflection mirror 111a and is incident on mirror 113. At this time, because surface 113′ of mirror 113 is coated to maximize the reflection rate of DUV light, the light incident on surface 113′ is reflected by mirror 113 and falls incident on the incident surface of the first rod lens 115a.

On the incident surface of the first rod lens 115a, the distribution of light is not uniform. But, the light exiting the light emitting surface of the first rod lens 115a has a uniform distribution. The light passing through the light emitting surface of the first rod lens 115a sequentially passes through the condenser lens 116 and the collimation lens 117 and reaches half mirror 120.

In the embodiment of FIG. 5, the second lamp 112b is to be used as a light source and the position of the second rod lens 115b is moved so that the second rod lens 115b is positioned at the front of the condenser lens 116. The mirror 113 is rotated so that the light radiated from the first lamp 112a may be reflected toward the second rod lens 115b.

When power is supplied to the second lamp 112b, UV light is radiated from the second lamp 112b. The light radiated from the second lamp 112b is reflected by the second oval reflection mirror 111b and falls incident on mirror 113. Because the other surface 113″ of the mirror 113 is provided with a coating layer to maximize the reflection rate of UV light, the light incident on the other surface 113″ of the mirror 113 is reflected by the mirror 113 and falls incident on the incident surface of the second rod lens 115b.

On the incident surface of the second rod lens 115b, the distribution of the light is not uniform. But, light exiting the light emitting surface of the second rod lens 115b has a uniform distribution. The light that passes through the light emitting surface of the second rod lens 115b sequentially passes through the condenser lens 116 and the collimation lens 117 and reaches half mirror 120.

In accordance with one or more embodiments, an illumination optical system is provided to have a plurality of light sources and a plurality of rod lenses corresponding to the plurality of light sources. In accordance with one or more embodiments, the rod lens 115a and 115b may be configured to be optimized for lights being emitted from the light sources 112a and 112b, respectively. In detail, the first rod lens 115a is a rod lens optimized for DUV light emitted from the first lamp 112a, and the second rod lens 115b is a rod lens optimized for UV light emitted from the second lamp 112b. In one embodiment, the illumination optical system may include a single rod lens and the position of this rod lens may be fixedly installed. In this case, the DUV light from the first light source 112a or the UV light from the second light source 112b may be incident to the rod lens. The rod lens may serve form a uniform light from the DUV light being incident from the first light source 112a, or form a uniform light from the UV light being incident from the second light source 112b.

Also, movement of the rod lens and/or mirror(s) including rotation of mirror 113 may be performed manually by a user or automatically based on an electrical signal. The illumination optical system may be additionally provided with at least one of an input unit for selecting the type of the light source to be used, a driving unit configured to move the position of the rod lens according to the type of the selected light source, and a driving unit configured to move or rotate the position of the mirror according to the type of the selected light source.

In some of the foregoing embodiments, the first and second lamps have been described to generate light in wavelength bands in the range of 200 nm and 300 nm and in the range of 300 nm and 450 nm, respectively. In alternative embodiments, the lamps may generate light in one or more different wavelength bands, e.g., first lamp 112a may radiate light in the wavelength band of 220 nm to 280 nm and the second lamp 112b may radiate light the wavelength band of 280 nm to 450 nm.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An illumination optical system, comprising:
a first light source configured to radiate light in a first band;
a first reflector to reflect the light from the first light source;
a second reflector to reflect light from the first reflector;
a second light source configured to radiate light in a second band;
a third reflector to reflect the light from the second light source; and
a moveable fourth reflector set at a first position to allow light from the first light source to pass and set at a second position to allow light from the second light source to be reflected.

2. The system of claim 1, further comprising:
a first lens configured to convert light from the second reflector into uniform light; and
a second lens configured to convert light from the fourth reflector into uniform light.

3. The system of claim 2, wherein:
the first lens is set to a position to pass light from the second reflector when the fourth reflector is set to the first position, and
the second lens is set to a position to pass light from the fourth reflector when the fourth reflector is set to the second position.

4. The system of claim 3, further comprising:
a first reflecting surface adjacent the first lens to reflect light toward the second reflector and the first reflector, and
a second reflecting surface adjacent the second lens to reflect light toward the fourth reflector and the third reflector.

5. The system of claim 1, wherein:
the first band is a ultraviolet band, and
the second band is a deep ultraviolet band.

6. The system of claim 1, further comprising:
a first coating on the second reflector made of a material to reflect light in the first band, and
a second coating on the fourth reflector made of a material to reflect light in the second band.

7. The system of claim 1, wherein the first reflector has two focal positions.

8. The system of claim 1, wherein:
the first light source is located at a first focal position, and
the second reflector is located at a second focal position.

9. The system of claim 8, wherein the third reflector has two focal positions.

10. The system of claim 9, wherein the second light source is at a first focal position of the third reflector, and wherein the fourth reflector is located at a second focal position of the third reflector.

11. An illumination optical system, comprising:
a first light source configured to radiate light in a first band;
a first reflector to reflect the light from the first light source;
a second reflector to reflect light from the first reflector;
a second light source configured to radiate light in a second band;
a third reflector to reflect the light from the second light source; and
a fourth reflector at a fixed position to pass light from the second reflector when light is output from the first light source and to reflect light from the third reflector when light is output from the second light source.

12. The system of claim 11, wherein:
the first band is an ultraviolet band, and
the second band is a deep ultraviolet band.

13. The system of claim 11, further comprising:
a first coating on the second reflector made of a material to reflect light in the first band, and
a second coating on the fourth reflector made of a material to reflect light in the second band.

14. The system of claim 11, wherein:
the first reflector has two focal positions, the first light source located at a first focal position and the second reflector located at a second focal position, and
the third reflector has two focal positions, the second light source located at a first focal position of the third reflector and the fourth reflector is located at a second focal position of the third reflector.

15. An illumination optical system, comprising:
a first reflector to reflect light of a first band from a first light source;
a second reflector to reflect light of a second band from a second light source; and
a moveable third reflector between the first and second reflectors, wherein the third reflector moves to a first position to reflect light from the first reflector and wherein the third reflector moves to a second position to reflect light from the second reflector.

16. The system of claim 15, wherein the first reflector is disposed in opposing relation to the second reflector.

17. The system of claim 15, wherein the third reflector rotates between the first and second positions.

18. The system of claim 15, wherein:
the first reflector has a first focal position corresponding to a location of the first light source and a second focal position corresponding to a location of the third reflector, and
the second reflector has a third focal position corresponding to a location of the second light source and a fourth focal position corresponding to a location of the third reflector.

19. The system of claim 15, further comprising:
a first coating on the first reflector made of a material to reflect light in the first band, and
a second coating on the second reflector made of a material to reflect light in the second band.

20. The system of claim 15, further comprising:
a first lens set to a position to receive light from the first reflector when the third reflector is set to the first position, and
the second lens is set to a position to receive light from the second reflector when the third reflector is set to the second position.
